(19) United States
(12) Patent Application Publication
(10) Pub. No.: US 2015/0201384 A1
(43) Pub. Date: Jul. 16, 2015

(54) METHOD FOR TRANSMITTER DIRECT CURRENT OFFSET COMPENSATION

(71) Applicant: QUALCOMM Incorporated, San Diego, CA (US)

(72) Inventor: Samel Celebi, Summit, NJ (US)

(73) Assignee: QUALCOMM INCORPORATED, San Diego, CA (US)

(21) Appl. No.: 14/152,862

(22) Filed: Jan. 10, 2014

(51) Int. Cl. H04W 52/24; H04B 1/40

(52) U.S. Cl. CPC H04W 52/241; H04B 1/40

(57) ABSTRACT

A system for transmitter DC offset compensation is operable by a network entity that communicates with at least one other network entity. The network entity determines a quality indicator for the at least one other network entity and adjusts a mixer bias voltage. The network entity observes for changes in the quality indicator and readjusts the mixer bias voltage based on the changes in the quality indicator to improve the quality indicator. The network entity continues to observe for changes in the quality indicator and continues to readjust the mixer bias voltage until the quality indicator is optimized.

### BACKGROUND

This application is directed to wireless communications systems, and more particularly to methods and apparatuses for transmitter direct current offset compensation in wireless communications systems.

A wireless network may be deployed over a defined geographical area to provide various types of services (e.g., voice, data, multimedia services, etc.) to users within that geographical area. The wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. A base station may be, or may include, a macrocell, a microcell, or a small cell. Microcells or small cells (e.g., picocells, femtocells, home nodeBs) are characterized by having generally much lower transmit power than macrocells, and may often be deployed without central planning. In contrast, macrocells are typically installed at fixed locations as part of a planned network infrastructure, and cover relatively large areas.

The 3rd Generation Partnership Project (3GPP) Long Term Evolution (LTE) advanced cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

Wireless radio transmitters using in wireless networks have evolved over the years from real intermediate frequency (IF) transmitters, to complex IF transmitters, to direct conversion (also known as Zero-IF) transmitters. In the Zero IF (ZIF) transmitters, a digital complex signal at baseband is interpolated to ease filtering requirements and then fed to digital to analog converters (DAC). The complex analog output of the DACs, still at baseband, is fed to an analog quadrature modulator. With the zero-IF architecture, the entire modulated signal is converted to a radio frequency (RF) carrier at the local oscillator (LO) frequency. Choosing a correct direct current (DC) offset is a common problem in direct conversion transceivers. In the case of the transmitters, unless estimated and compensated for effectively, the DC offset degrades the transmit (Tx) waveform quality. The DC offset is applied as a correction to a mixer in the form of a bias voltage.

In an existing solution, in frequency domain the DC offset is represented as a tone at a carrier frequency. A device can estimate a strength of the tone directly either using a spectrum analyzer or indirectly in the form of an error vector magnitude (EVM) measurement using a signal analyzer. The device can apply small corrections to a mixer output to minimize the strength of the tone or the measured EVM. Either approach requires expensive equipment and does not correct for long term time variations of the DC offset.

In an alternative existing solution, a device can route a RF Tx signal back to a local receiver thru a self-loopback path and down-converted to baseband frequencies. The device can adjust a frequency difference between a Tx LO and a receive (Rx) LO, to configure a DC offset tone location. The device can apply small corrections to a Tx mixer output to minimize a strength of the tone and the Tx DC offset. This approach requires additional hardware in the form of an additional Rx LO and a self-loopback path.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In accordance with one or more aspects of the implementations described herein, there is provided a system and method for transmitter DC offset compensation. In one implementation, a network entity may communicate with at least one other network entity. The network entity may determine a quality indicator for the at least one other network entity and adjust a mixer bias voltage. The network entity may observe for changes in the quality indicator and readjust the mixer bias voltage based on the changes in the quality indicator to improve the quality indicator.

### BRIEF DESCRIPTION OF THE DRAWINGS

FIG. 1A is an illustration of an example wireless communication network.

FIG. 1B is a block diagram illustrating an example of a communication system for transmitter DC offset compensation.

FIG. 2 is a block diagram illustrating an example of communication system components.

FIG. 3 illustrates an example of a methodology for transmitter DC offset compensation.

FIG. 4 shows an example of an apparatus for transmitter DC offset compensation, in accordance with the methodology of FIG. 3.

### DETAILED DESCRIPTION

Techniques for transmitter DC offset compensation are described herein. An incorrectly set DC offset for a direct conversion transmitter reduces transmission quality. The subject disclosure provides a technique for setting optimal DC offsets for direct conversion transceivers in an efficient and economical manner, without the need for additional hardware, by receiving feedback from another network device in the form of quality indicators. The technique involves using the quality indicators to make small adjustments to the DC offset until an optimal setting is reached.

In the subject disclosure, the word “exemplary” to the extent used herein means “serving as an example, instance, or illustration”. Any aspect or design described herein as “exemplary” is not necessarily to be construed as preferred or advantageous over other aspects or designs. Rather, use of the word exemplary is intended to present concepts in a concrete fashion.

The techniques may be used for various wireless communication networks such as wireless wide area networks (WWANs) and wireless local area networks (WLANs). The terms “network” and “system” are often used interchangeably. The WWANs may be code division multiple access (CDMA), time division multiple access (TDMA), frequency division multiple access (FDMA), orthogonal frequency-division multiple access (OFDMA), single carrier frequency division multiple access (SC-FDMA) and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

The techniques described herein may be used for the wireless networks and radio technologies mentioned above as well as other wireless networks and radio technologies. For clarity, certain aspects of the techniques are described below for 3GPP network and WLAN, and LTE and WLAN terminology is used in much of the description below.

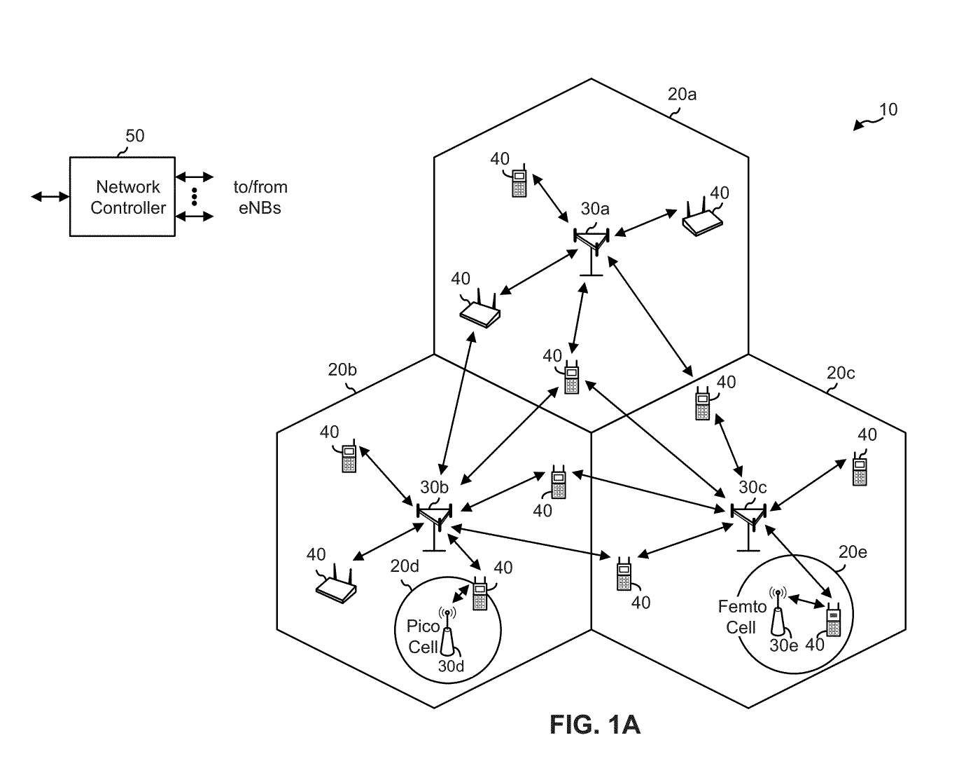

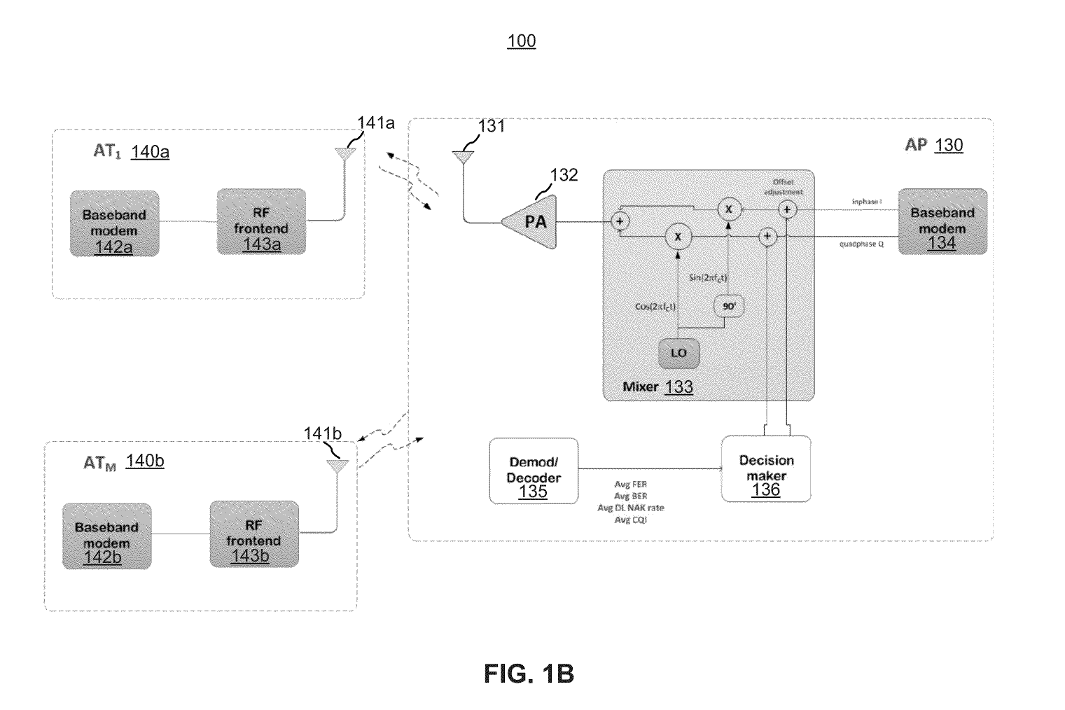

FIG. 1A is an illustration of an example wireless communication network 10, which may be an LTE network or some other wireless network. Wireless network 10 may include a number of evolved Node Bs (eNBs) 30 and other network entities. An eNB may be an entity that communicates with mobile entities (e.g., user equipment (UE), access terminals, etc.) and may also be referred to as a base station, a Node B, an access point, or other terminology. Although the eNB typically has more functionalities than a base station, the terms “eNB” and “base station” are used interchangeably herein. Each eNB 30 may provide communication coverage for a particular geographic area and may support communication for mobile entities located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macrocell, a picocell, a small cell, and/or other types of cell. A macrocell may cover a relatively large geographic area (e.g., several kilometers in radius) and may allow unrestricted access by UEs with service subscription. A picocell may cover a relatively small geographic area and may allow unrestricted access by UEs with service subscription. A small cell such as a femtocell may cover a relatively small geographic area (e.g., a home) and may allow restricted access by UEs having association with the small cell (e.g., UEs in a Closed Subscriber Group (CSG)). In the example shown in FIG. 1A, eNBs 30a, 30b, and 30c may be macro eNBs for macrocell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a small cell eNB, a small cell base station, or a small cell access point (FAP) for a small cell 20e.

Wireless network 10 may also include relays (not shown in FIG. 1A). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may be a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, or other terminology. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, or other device. A UE may be able to communicate with eNBs, relays, etc. A UE may also be able to communicate peer-to-peer (P2P) with other UEs.

Wireless network 10 may support operation on a single carrier or multiple carriers for each of the downlink (DL) and uplink (UL). A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the DL carrier.

Carrier aggregation allows expansion of effective bandwidth delivered to a user terminal through concurrent use of radio resources across multiple carriers. When carriers are aggregated, each carrier is referred to as a component carrier. Multiple component carriers are aggregated to form a larger overall transmission bandwidth. Two or more component carriers can be aggregated to support wider transmission bandwidths.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), or MIMO. For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

FIG. 1B illustrates an example of a communication system for transmitter DC offset compensation. For illustration purposes, various aspects of the disclosure will be described in the context of one or more access terminals, access points, and network entities that communicate with one another. It should be appreciated, however, that the teachings herein may be applicable to other types of apparatus or other similar apparatus that are referenced using other terminology. For example, in various implementations access points may be referred to or implemented as base stations, NodeBs, eNodeBs, small cells, macrocells, or other terminology. Access terminals may be referred to or implemented as user equipment (UEs), mobile stations, or other terminology. It should be further appreciated that the teachings herein may be applicable to communication scenarios between a plurality of access points or between a plurality of access terminals.

An access point 130 in the system 100 may provide access to one or more services (e.g., network connectivity) for one or more wireless terminals (e.g., access terminal, UE, mobile entity, mobile device) 140. The access point 130 may communicate with one or more network entities (not shown) to facilitate wide area network connectivity. Such network entities may take various forms such as, for example, one or more radio and/or core network entities.

In various implementations, the network entities may be responsible for or otherwise be involved with handling: network management (e.g., via an operation, administration, management, and provisioning entity), call control, session management, mobility management, gateway functions, interworking functions, or some other suitable network functionality. In a related aspect, mobility management may relate to or involve: keeping track of the current location of access terminals through the use of tracking areas, location areas, routing areas, or some other suitable technique; controlling paging for access terminals; and providing access control for access terminals. Also, two of more of these network entities may be co-located and/or two or more of such network entities may be distributed throughout a network.

In an example implementation, an access point 130 may communicate with at least one other network entity. The at least one other network entity may, for example, include one or more access terminals 140. The communication may include downlink signals from the access point 130 to the access terminals 140 and uplink signals from the access terminals 140 to the access point 130.

In one example implementation, each access terminal 140 may include at least a baseband modem 142, a RF frontend 143, and an antenna 141. The RF frontend 143 may include various circuitry between the antenna 141 and an IF stage. The RF frontend 143 may process signals at an original incoming RF before they are converted to a lower IF. The baseband modem 142 of the access terminal 140 may function to modulate and demodulate baseband signals to and from the RF frontend 143.

In a related aspect, the access point 130 may include at least the antenna 131, a power amplifier 132, a mixer 133, a baseband modem 134, a demodulator 135, and a decision maker 136. In an example aspect, the access point 130 may transmit downlink signals from the access point antenna 131 to the access terminal antennas 141. The baseband modem 134 may create in-phase and quadrature components of a baseband signal. The in-phase and quadrature components of the baseband signal may be inputted into the mixer 133. The mixer may add DC offsets for the in-phase and quadrature components using an in-phase mixer bias voltage and a quadrature phase mixer bias voltage to the baseband signal, combine the offset signal with a signal from a LO, and output a mixer signal to the power amplifier 132. The power amplifier 132 may increase a power of the mixer signal which the antenna 131 transmits.

In an example implementation, the decision maker 136 may control the offset adjustment of the mixer 133. The access point 130 may be in existing communications with the access terminals 140. The decision maker 136 may determine a quality indicator for the access terminals 140. The quality indicator may be based on a quality indicator message received from the access terminals 140. In one implementation, the demodulator 135 may receive the quality indicator message from signals from the access terminals 140. The quality indicator may, for example, include at least one of Frame Error Rate (FER), Bit Error Rate (BER), Negative Acknowledgment (NAK), or Channel Quality Indication (CQI). The FER measurement is an indicator of a ratio of data received with errors to total data received. The BER indicates a ratio of bit errors to total number of bits received over a time internal. NAK is a transmission control character sent to reject a previously received message or to indicate an error in the previously received message. The CQI is an indicator of downlink channel quality. In a related aspect, the decision maker 136 may determine the quality indicator based on a weighted average of quality indicator messages received from a plurality of access terminals 140.

The decision maker 136 may make an initial adjustment to the in-phase or quadrature component mixer bias voltage to change the in-phase or quadrature component DC offsets. For example, the decision maker may choose to increase or decrease the in-phase mixer bias voltage slightly. This change to the in-phase DC offset may change the quality of downlink signals from the access point 130 to the access terminals 140. The change in quality of the downlink signals may be reported back to the access point 130 by the access terminal 140 via the quality indicator.

The decision maker 136 may observe for changes in the quality indicator reported by the access terminals 140. The decision maker 136 may readjust the mixer bias voltage for the in-phase or the quadrature component based on the changes in the quality indicator to improve the quality indicator. In an example implementation, the decision maker 136 may adjust the in-phase mixer bias voltage further in a direction of the initial adjustment, in response to observing the quality indicator improve. However, the decision maker 136 may adjust the in-phase mixer bias voltage in a direction opposite of the initial adjustment, in response to observing the quality indicator degrade. To illustrate, for example, if the initial adjustment increased the in-phase mixer bias voltage and the quality indicator shows improvement, then the decision maker 136 may again increase the in-phase mixer bias voltage. However, if the initial adjustment increased the in-phase mixer bias voltage and the quality indicator shows degradation, then the decision maker 136 may decrease the in-phase mixer bias voltage.

In a related aspect, the steps for adjusting the in-phase mixer bias voltage may be repeated in adjusting the quadrature phase mixer bias voltage to improve the quality indicator. The decision maker 136 may continue to monitor for the changes of the quality indicator while making adjustments to the in-phase and quadrature mixer bias voltages until the quality indicator is optimized. For example, the decision maker 136 may continue to make adjustments to the in-phase and quadrature phase mixer bias voltage until the BER is observed to be at a minimum value. In a further related aspect, the decision maker 136 may adjust the in-phase and quadrature phase mixer bias voltage for a plurality of different modulation formats.

It should be understood that the functions and components of the access point 130 may also be applied to an access terminal or some other network entity. The functions and components of the access terminals 140 may also be applied to an access point or some other network entity. The methods disclosed herein performed by the access point 130 or the access terminals 140 in the examples may also be performed by other network comprising transmitter components or functions.

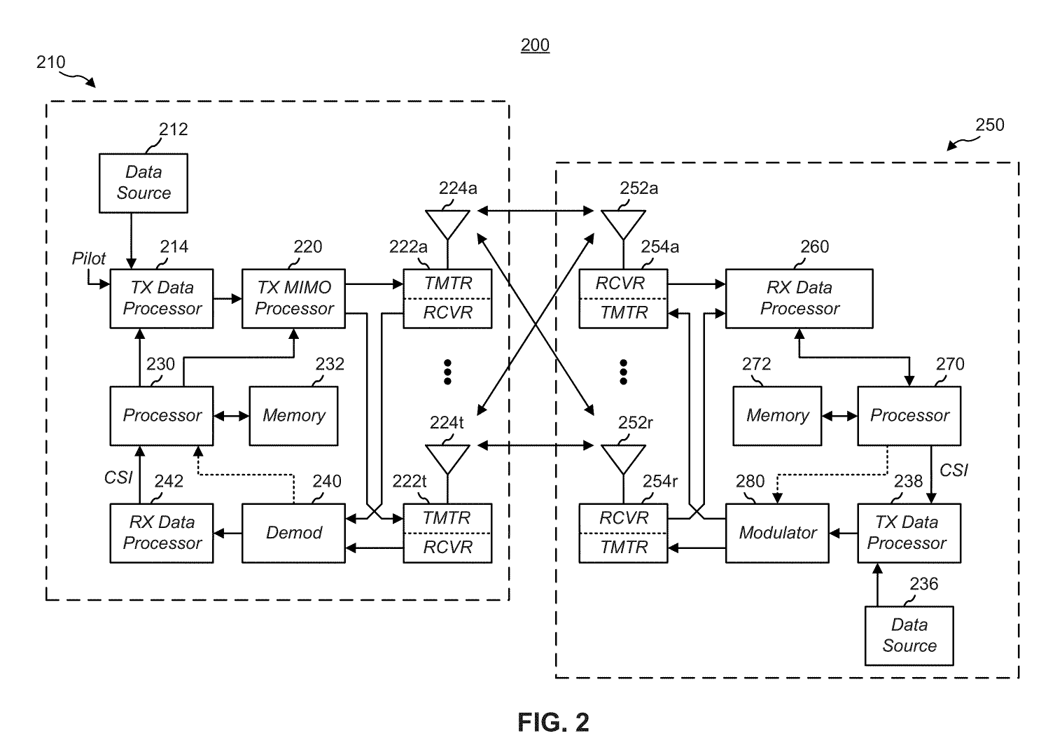

FIG. 2 illustrates a system 200 including a transmitter system 210 (also known as the access point, base station, or eNB) and a receiver system 250 (also known as access terminal, mobile device, or UE) in an LTE MIMO system 200. In the present disclosure, the transmitter system 210 may correspond to a WS-enabled eNB or the like, whereas the receiver system 250 may correspond to a WS-enabled UE or the like.

At the transmitter system 210, traffic data for a number of data streams is provided from a data source 212 to a transmit (TX) data processor 214. Each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain implementations, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

As used herein, an access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macrocell, a macro node, a Home eNB (HeNB), a small cell, a small node, a pico node, or some other similar terminology.

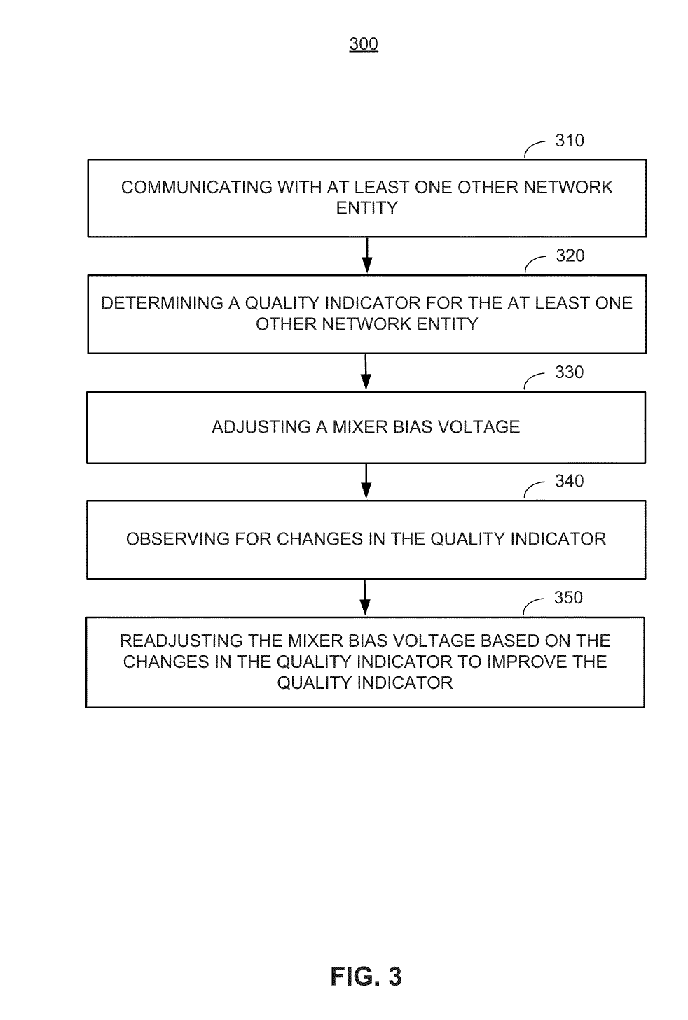

In accordance with one or more aspects of the implementations described herein, with reference to FIG. 3, there is shown a methodology 300 for transmitter DC offset compensation. The method 300, operable by a network entity or component(s) thereof, may involve, at 310 communicating with at least one other network entity. The network entity may each be an access terminal, an access point, or another wireless network entity. In an example implementation, the network entity may be the access point 130 communicating with the access terminals 140, as shown in FIG. 1B.

The method 300 may involve, at 320, determining a quality indicator for the at least one other network entity. In an example implementation, the demodulator 135 of the access point 130 may receive quality indicator messages each including a BER from the access points 140, as shown in FIG. 1B. The decision maker 136 of the access point 1130 may average the BERs of the quality indicator messages to determine the quality indicator, as shown in FIG. 1B.

The method 300 may involve, at 330, adjusting a mixer bias voltage. In an example implementation, decision maker 136 of the access point 130 may control the mixer 133 to increase an in-phase mixer bias voltage, as shown in FIG. 1B.

The method 300 may involve, at 340, observing for changes in the quality indicator. In an example implementation, the demodulator 135 of the access point 130 may receive quality indicator messages each including a BER from the access points 140. The decision maker 136 of the access point 1130 may calculate a weighted average of the BERs of the quality indicator messages to determine the quality indicator, as shown in FIG. 1B. The decision maker 136 may compare the weighted average BER to previous weighted average BERs.

The method 300 may involve, at 350, readjusting the mixer bias voltage based on the changes in the quality indicator to improve the quality indicator. In an example implementation, decision maker 136 of the access point 130 may control the mixer 133 to increase an in-phase mixer bias voltage, in response to an improvement to the weighted average BER, as shown in FIG. 1B.

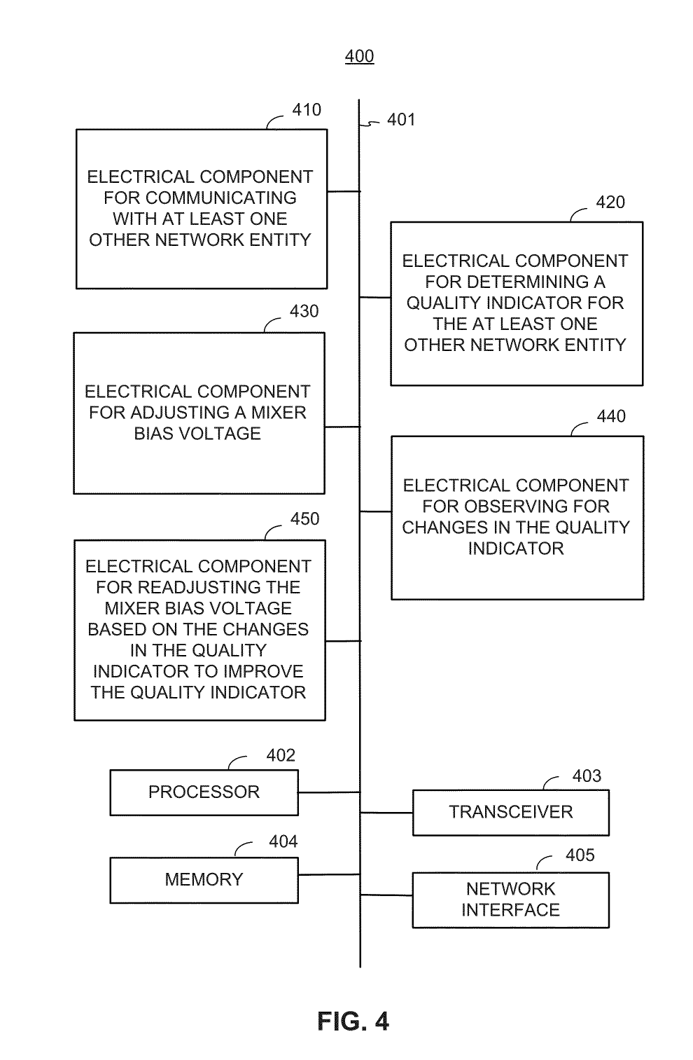

In accordance with one or more aspects of the implementations described herein, FIG. 4 shows a design of an apparatus 400 for transmitter DC offset compensation. The exemplary apparatus 400 may be configured as a computing device or as a processor or similar device/component for use within. In one example, the apparatus 400 may include functional blocks that can represent functions implemented by a processor, software, or combination thereof (e.g., firmware). In another example, the apparatus 300 may be a system on a chip (SoC) or similar integrated circuit (IC).

In one implementation, apparatus 400 may include an electrical component or module 410 for communicating with at least one other network entity. The electrical component 410 may include, for example, a processor coupled to a memory, the memory holding program instructions for communicating with the other network entity.

The apparatus 400 may include an electrical component 420 for determining a quality indicator for the at least one other network entity. For example, an algorithm executable by a processor may include operations for receiving a BER from the other network entity.

The apparatus 400 may include an electrical component 430 for adjusting a mixer bias voltage. For example, an algorithm executable by a processor may include operations for increasing the mixer bias voltage.

The apparatus 400 may include an electrical component 440 for observing for changes in the quality indicator. For example, an algorithm executable by a processor may include operations for receiving a new BER from the other network entity and comparing the new BER with previously received BER.

The apparatus 400 may include an electrical component 450 for readjusting the mixer bias voltage based on the changes in the quality indicator to improve the quality indicator. For example, an algorithm executable by a processor may include operations for further increasing the mixer bias voltage if the new BER is an improvement over the previously received BER.

In further related aspects, the apparatus 400 may optionally include a processor component 402. The processor 402 may be in operative communication with the components 410-450 via a bus 401 or similar communication coupling. The processor 402 may effect initiation and scheduling of the processes or functions performed by electrical components 410-450.

In yet further related aspects, the apparatus 400 may include a radio transceiver component 403. A standalone receiver and/or standalone transmitter may be used in lieu of or in conjunction with the transceiver 403. The apparatus 400 may also include a network interface 405 for connecting to one or more other communication devices or the like. The apparatus 400 may optionally include a component for storing information, such as, for example, a memory device/component 404. The computer readable medium or the memory component 404 may be operatively coupled to the other components of the apparatus 400 via the bus 401 or the like. The memory component 404 may be adapted to store computer readable instructions and data for affecting the processes and behavior of the components 410-450, and subcomponents thereof, or the processor 402, or the methods disclosed herein. The memory component 404 may retain instructions for executing functions associated with the components 410-450. While shown as being external to the memory 404, it is to be understood that the components 410-450 can exist within the memory 404. It is further noted that the components in FIG. 4 may comprise processors, electronic devices, hardware devices, electronic sub-components, logical circuits, memories, software codes, firmware codes, etc., or any combination thereof.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein, but is to be accorded the widest scope consistent with the principles and novel features disclosed herein.

1. A method of wireless communication by a network entity, comprising:
communicating with at least one other network entity;
determining a quality indicator for the at least one other network entity;
adjusting a mixer bias voltage;
observing for changes in the quality indicator; and
readjusting the mixer bias voltage based on the changes in the quality indicator to improve the quality indicator.

2. The method of claim 1, wherein the mixer bias voltage comprises at least one of a mixer in-phase bias voltage or a mixer quadrature phase bias voltage.

3. The method of claim 1, wherein:
adjusting the mixer bias voltage comprises adjusting in an initial direction; and
readjusting the mixer bias voltage comprises:
adjusting the mixer bias voltage further in the initial direction, in response to observing the quality indicator improve, or
adjusting the mixer bias voltage opposite of the initial direction, in response to observing the quality indicator degrade.

4. The method of claim 1, wherein observing for changes in the quality indicator and readjusting the mixer bias voltage continues until the quality indicator is optimized.

5. The method of claim 1, wherein the quality indicator comprises at least one of Frame Error Rate (FER), Bit Error Rate (BER), Negative Acknowledgment (NAK), or Channel Quality Indication (CQI).

6. The method of claim 1, wherein determining the quality indicator comprises calculating a weighted average for the at least one other network entity.

7. The method of claim 1, wherein readjusting the mixer bias voltage comprises readjusting the mixer bias voltage for a plurality of different modulation formats.

8. The method of claim 1, wherein the network entity is at least one of an access point or an access terminal.

9. A wireless communication apparatus, comprising:
means for communicating with at least one other network entity;
means for determining a quality indicator for the at least one other network entity;
means for adjusting a mixer bias voltage;
means for observing for changes in the quality indicator; and
means for readjusting the mixer bias voltage based on the changes in the quality indicator to improve the quality indicator.

10. The method of claim 9, wherein the mixer bias voltage comprises at least one of a mixer in-phase bias voltage or a mixer quadrature phase bias voltage.

11. The apparatus of claim 9, wherein:
adjusting the mixer bias voltage comprises adjusting in an initial direction; and
readjusting the mixer bias voltage comprises:
adjusting the mixer bias voltage further in the initial direction, in response to observing the quality indicator improve, or
adjusting the mixer bias voltage opposite of the initial direction, in response to observing the quality indicator degrade.

12. The apparatus of claim 9, wherein observing for changes in the quality indicator and readjusting the mixer bias voltage continues until the quality indicator is optimized.

13. The apparatus of claim 9, wherein determining the quality indicator comprises calculating a weighted average for the at least one other network entity.

14. The apparatus of claim 9, wherein readjusting the mixer bias voltage comprises readjusting the mixer bias voltage for a plurality of different modulation formats.

15. The apparatus of claim 9, wherein the network entity is at least one of an access point or an access terminal.

16. A computer program product, comprising:
a non-transitory computer-readable medium comprising:
code for communicating with at least one other network entity;
code for determining a quality indicator for the at least one other network entity;
code for adjusting a mixer bias voltage;
code for observing for changes in the quality indicator; and
code for readjusting the mixer bias voltage based on the changes in the quality indicator to improve the quality indicator.

17. The computer program product of claim 16, wherein the mixer bias voltage comprises at least one of a mixer in-phase bias voltage or a mixer quadrature phase bias voltage.

18. The computer program product of claim 16, wherein:
adjusting the mixer bias voltage comprises adjusting in an initial direction; and
readjusting the mixer bias voltage comprises:
adjusting the mixer bias voltage further in the initial direction, in response to observing the quality indicator improve, or
adjusting the mixer bias voltage opposite of the initial direction, in response to observing the quality indicator degrade.

19. The computer program product of claim 16, wherein observing for changes in the quality indicator and readjusting the mixer bias voltage continues until the quality indicator is optimized.

20. The computer program product of claim 16, wherein determining the quality indicator comprises calculating a weighted average for the at least one other network entity.

21. A wireless communication apparatus, comprising:
a radio frequency (RF) transceiver configured to:
communicate with at least one other network entity;
at least one processor configured to:
determine a quality indicator for the at least one other network entity;
adjust a mixer bias voltage;
observe for changes in the quality indicator; and
readjust the mixer bias voltage based on the changes in the quality indicator to improve the quality indicator; and
a memory coupled to the at least one processor for storing data.

22. The apparatus of claim 21, wherein the mixer bias voltage comprises at least one of a mixer in-phase bias voltage or a mixer quadrature phase bias voltage.

23. The apparatus of claim 21, wherein observing for changes in the quality indicator and readjusting the mixer bias voltage continues until the quality indicator is optimized.

24. The apparatus of claim 21, wherein determining the quality indicator comprises determining a quality indicator average from the at least one other network entity.
